(19) United States
(12) Patent Application Publication
(10) Pub. No.: US 2023/0101454 A1
(43) Pub. Date: Mar. 30, 2023

(54) INFORMATION PROCESSING DEVICE AND INFORMATION PROCESSING SYSTEM

(71) Applicant: SEIKO EPSON CORPORATION, Tokyo (JP)

(72) Inventor: Shintaro NAGASAKI, HARAMURA SUWA-GUN (JP)

(73) Assignee: SEIKO EPSON CORPORATION, Tokyo (JP)

(21) Appl. No.: 17/954,299

(22) Filed: Sep. 27, 2022

(30) Foreign Application Priority Data
Sep. 29, 2021 (JP) 2021-159310

(51) Int. Cl. A63B 24/00; G06K 7/10; A63B 69/00; A63B 71/06

(52) U.S. Cl. CPC A63B 24/0062; G06K 7/10425; A63B 69/0028; A63B 71/0616; A63B 2220/836; A63B 2220/12; A63B 2225/54

(57) ABSTRACT

An information processing device includes a communication unit configured to communicate with a measurement equipment mounted on a competitor who participates in a competition, and a traffic regulation compliance determination unit configured to correct a time of the competition when determining, based on the positional information of the measurement equipment, that the competitor is complying with a traffic regulation stopping the competitor from proceeding while the competitor is prohibited from proceeding.

The present application is based on, and claims priority from JP Application Serial Number 2021-159310, filed Sep. 29, 2021, the disclosure of which is hereby incorporated by reference herein in its entirety.

### BACKGROUND

### 1. Technical Field

The present disclosure relates to an information processing device and an information processing system.

### 2. Related Art

For example, in a marathon race, a competition rank of each of competitors is determined based on a competition time of each of the competitors.

Further, for example, there has been examined a virtual marathon race that enables respective competitors to participate in a competition on different dates or at different times.

JP-A-2008-299535 describes a competition management server that enables respective competitors to participate in a competition on different dates or at different times and achieves a virtual marathon race. In the competition management server, an actual competition time is corrected based on competition conditions under which the actual competition time is acquired and reference competition conditions. With this, unfairness caused by differences in the competition conditions of the respective competitors is eliminated. Examples of the competition conditions include temperature conditions, humidity conditions, and weather conditions.

Although the technique described in JP-A-2008-299535 attempts to eliminate unfairness caused by competition conditions relating to a temperature and the like, the technique has not been sufficient yet.

### SUMMARY

In order to solve the above-mentioned problem, according to one aspect, an information processing device includes a communication unit configured to communicate with a measurement equipment mounted on a competitor who participates in a competition, and a traffic regulation compliance determination unit configured to correct a time of the competition, when determining, based on positional information of the measurement equipment, that the competitor is complying with a traffic regulation stopping the competitor from proceeding while the competitor is prohibited from proceeding.

In order to solve the above-mentioned problem, according to one aspect, an information processing system includes a GNSS reception unit mounted on a competitor who participates in a competition, and configured to acquire positional information of the competitor, and a traffic regulation compliance determination unit configured to correct a time of the competition, when determining, based on the positional information, that the competitor is complying with a traffic regulation stopping the competitor from proceeding while the competitor is prohibited from proceeding.

### BRIEF DESCRIPTION OF THE DRAWINGS

FIG. 1 is a view illustrating a schematic configuration example of an information processing system according to an exemplary embodiment, which is applied to a virtual marathon race.

FIG. 2 is a view illustrating a schematic configuration example of a measurement equipment in the exemplary embodiment.

FIG. 3 is a view illustrating a schematic configuration example of a competition management server in the exemplary embodiment.

FIG. 4 is a view illustrating one example of a procedure of processing for measurement and transmission of a measurement result, which is executed by the measurement equipment, in the exemplary embodiment.

FIG. 5 is a view illustrating one example of a procedure of processing executed by the competition management server in the exemplary embodiment.

FIG. 6 is a view illustrating another example of the procedure of the processing executed by the competition management server in the exemplary embodiment.

FIG. 7 is a view illustrating one example of A-th competition performance information about a competitor A in the exemplary embodiment.

FIG. 8 is a view illustrating one example of B-th competition performance information about a competitor B in the exemplary embodiment.

FIG. 9 is a view illustrating one example of A-th competition result information about the competitor A in the exemplary embodiment.

FIG. 10 is a view illustrating one example of B-th competition result information about the competitor B in the exemplary embodiment.

### DESCRIPTION OF EXEMPLARY EMBODIMENTS

An exemplary embodiment is described below with reference to the accompanying drawings.

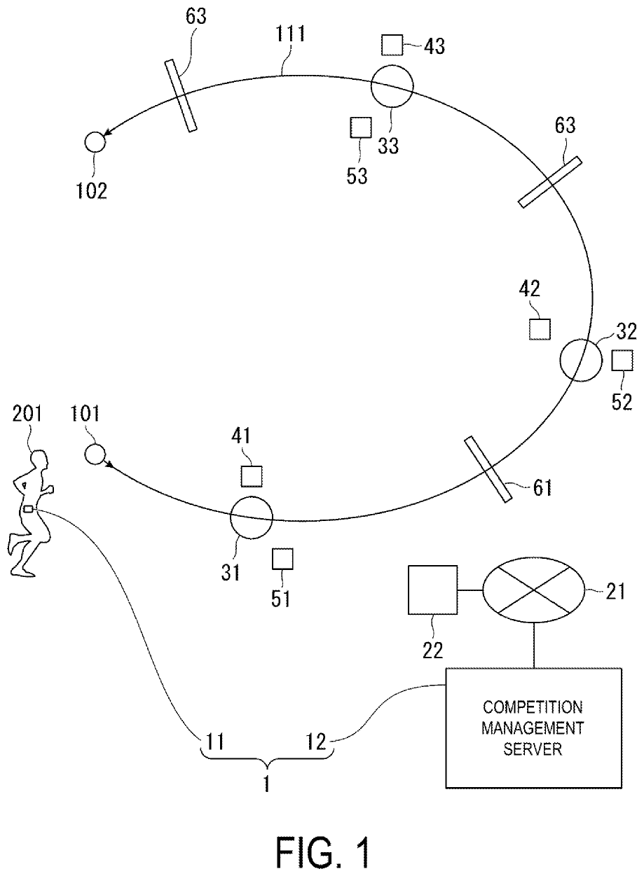

FIG. 1 is a view illustrating a schematic configuration example of an information processing system 1 according to an exemplary embodiment, which is applied to a virtual marathon race.

The information processing system 1 is used as a competition management system that manages a competition of the virtual marathon race.

The information processing system 1 includes a measurement equipment 11 and a competition management server 12.

The competition management server 12 is one example of an information processing device.

FIG. 1 illustrates a course 111 of the virtual marathon race. The course 111 is a fixed route from a starting point 101 to a goal point 102.

In the present exemplary embodiment, a first intersection 31, a second intersection 32, and a third intersection 33 are present in the course 111.

A first traffic light 41 is present in the vicinity of the first intersection 31. Further, a first camera 51 is installed in the vicinity of the first intersection 31.

Similarly, a second traffic light 42 is present in the vicinity of the second intersection 32. Further, a second camera 52 is installed in the vicinity of the second intersection 32.

Similarly, a third traffic light 43 is present in the vicinity of the third intersection 33. Further, a third camera 53 is installed in the third intersection 33.

Here, in the present exemplary embodiment, the three traffic lights including the first traffic light 41, the second traffic light 42, and the third traffic light 43 are illustrated. However, the number of traffic light present in the course 111 may be a freely-selected number being one or greater, and the installation positions of the traffic lights present in the course 111 may be freely-selected positions.

Further, in the present exemplary embodiment, a pedestrian crosswalk is present at each of the installation positions of the first traffic light 41, the second traffic light 42, and the third traffic light 43. Here, in the present exemplary embodiment, the intersection such as the first intersection 31, the second intersection 32, and the third intersection 33 is illustrated as a location at which the pedestrian crosswalk is present. However, in place of an intersection, the pedestrian crosswalk may be present at a location other than an intersection.

The first camera 51 is arranged and installed so as to capture an image of a range including the first traffic light 41 and the vicinity of the pedestrian crosswalk of the first intersection 31.

Similarly, the second camera 52 is arranged and installed so as to capture an image of a range including the second traffic light 42 and the vicinity of the pedestrian crosswalk of the second intersection 32.

Similarly, the third camera 53 is arranged and installed so as to capture an image of a range including the third traffic light 43 and the vicinity of the pedestrian crosswalk of the third intersection 33.

Here, the range captured by each of the first camera 51, the second camera 52, and the third camera 53 is not necessarily limited to the range in the present exemplary embodiment, and other ranges may be used.

In the present exemplary embodiment, a first RFID passing gate 61, a second RFID passing gate 62, and a third RFID passing gate 63 are present in the course 111.

The first RFID passing gate 61 is installed between the first intersection 31 and the second intersection 32.

The second RFID passing gate 62 is installed between the second intersection 32 and the third intersection 33.

The third RFID passing gate 63 is installed between the third intersection 33 and the goal point 102.

Note that RFID is an abbreviation for Radio Frequency Identification, and is a technique of reading and writing information stored in an RF tag with an electric wave in a non-contact manner. In the present exemplary embodiment, the measurement equipment 11 has a function as the RF tag.

Here, in the present exemplary embodiment, the three RFID passing gates including the first RFID passing gate 61, the second RFID passing gate 62, and the third RFID passing gate 63 are illustrated. However, the number of RFID passing gates installed in the course 111 may be a freely-selected number being one or greater, and the installation positions of the RFID passing gates installed in the course 111 may be freely-selected positions.

FIG. 1 illustrates a network 21 and a base station device 22.

For example, the network 21 is the Internet, but may be another network.

In the present exemplary embodiment, the measurement equipment 11 and the competition management server 12 communicate with each other via the network 21 and the base station device 22.

Specifically, the measurement equipment 11 and the base station device 22 communicate with each other in a wireless manner. The base station device 22 and the competition management server 12 communicate with each other via the network 21. The base station device 22 relays a communication content between the measurement equipment 11 and the competition management server 12. With this, the measurement equipment 11 and the competition management server 12 communicate with each other.

Note that, in FIG. 1, one base station device 22 is illustrated. For example, a plurality of base station devices are provided at different positions near the course 111, and communication is performed between a base station device that is closest to the position of the measurement equipment 11 and the measurement equipment 11.

Here, in the present exemplary embodiment, as a method of communication between the measurement equipment 11 and the competition management server 12, a Low Power Wide Area (LPWA) method is used, but another communication method may be used.

Further, in the present exemplary embodiment, the network 21 and the base station device 22 are used for LPWA communication. However, the configuration for communication between the measurement equipment 11 and the competition management server 12 is not limited to the configuration in the present exemplary embodiment, and another configuration may be used.

FIG. 1 illustrates a competitor 201 being a person who participates in a virtual marathon competition. Note that the competitor may also referred to as a runner or the like.

The measurement equipment 11 is mounted on the competitor 201. This mounting may also be referred to wearing or the like.

Here, the measurement equipment 11 may be mounted on any part of the competitor 201, such as a waist and a wrist. The measurement equipment 11 may be directly mounted on a body of the competitor 201, or may be stored in clothes of the competitor 201 and thus mounted on the competitor 201.

As a specific example, the measurement equipment 11 may be stored in clothes of the competitor 201 near the waist. As another specific example, the measurement equipment 11 may have a shape similar to a wrist watch, and may be mounted on the competitor 201 around a wrist.

Note that the present exemplary embodiment illustrates a case in which the measurement equipment 11 is integrated as one equipment piece. In another example, the functions of the measurement equipment 11 may be divided into a plurality of equipment pieces, and those equipment pieces may be mounted to respective parts of the competitor 201.

FIG. 1 illustrates one competitor 201 and one measurement equipment 11. However, a plurality of competitors participate in the virtual marathon race. Further, for example, different measurement equipment pieces are mounted on the respective competitors. However, competitors on different dates or at different times may use a common measurement equipment piece.

The virtual marathon race in the present exemplary embodiment adopts a time-sharing system, and a plurality of competitors run in the course 111. The respective competitors may run in the course 111 on different dates or at different times. Even when the competitors participate in the competition on different dates or at different times, the information processing system 1 according to the present exemplary embodiment suppresses a sense of unfairness caused by traffic situations or the like.

In the present exemplary embodiment, the information processing system 1 includes the measurement equipment 11 and the competition management server 12, and may be understood to include one or more of the first camera 51, the second camera 52, and the third camera 53, the first RFID passing gate 61, the second RFID passing gate 62, and the third RFID passing gate 63, and the network 21 and the base station device 22.

With reference to FIG. 1, an outline of processing executed by the information processing system 1 during the virtual marathon race is illustrated.

In the present exemplary embodiment, the competitor 201 and the measurement equipment 11 described in a representative manner. The same holds true for other competitors and other measurement equipment.

The competitor 201 wears the measurement equipment 11, and runs from the starting point 101 to the goal point 102 along the course 111.

While the competitor 201 participates in the competition of the virtual marathon race, communication is performed between the measurement equipment 11 and the competition management server 12, and the competition management server 12 receives information transmitted from the measurement equipment 11 to the competition management server 12. Subsequently, the competition management server 12 manages a condition of the competition in which the competitor 201 participates, based on the received information.

Here, identification information for identifying the measurement equipment 11 may be allocated to the measurement equipment 11. Further, the competition management server 12 may identify the measurement equipment 11, which is a transmission source of the received information, based on the identification information. In this case, the identification information may be stored in the measurement equipment 11, and may be contained in information transmitted from the measurement equipment 11 to the competition management server 12.

Note that the present exemplary embodiment illustrates a configuration of identifying the competitor 201 on which the measurement equipment 11 is mounted, based on the identification information about the measurement equipment 11. As another example, in place of the identification information about the measurement equipment 11, identification information about the competitor 201 may be used. Alternatively, identification information, which is issued by the competition management server 12 when the competition starts, may be used. In other words, it is only required that the respective competitors can be identified when the plurality of competitors participate in the virtual marathon race.

Under a state in which the first traffic light 41 prohibits pedestrians from proceeding, the competitor 201 stands by at a position just before crossing the pedestrian crosswalk of the first intersection 31 until the first traffic light 41 permits proceeding of a pedestrian.

Here, for example, a state in which the first traffic light 41 prohibits proceeding of a pedestrian corresponds to a state in which red-colored light is emitted. Further, a state in which the first traffic light 41 permits proceeding of a pedestrian corresponds to a state in which blue-colored light is emitted, for example.

Note that the first traffic light 41 may have a state of calling a pedestrian's attention during proceeding, and such a state corresponds to a state in which blue-colored light is blinking, for example.

In the present exemplary embodiment, the state in which the first traffic light 41 prohibits proceeding of a pedestrian corresponds to a state of prohibiting proceeding of the competitor 201. Further, in the present exemplary embodiment, the state in which the first traffic light 41 permits proceeding of a pedestrian corresponds to a state of permitting proceeding of the competitor 201.

The first camera 51 captures an image of a state in which the competitor 201 comes toward the pedestrian crosswalk of the first intersection 31 and crosses the pedestrian crosswalk. Subsequently, the first camera 51 transmits information about the captured image to the competition management server 12. The competition management server 12 receives the information about the image that is transmitted from the first camera 51 to the competition management server 12. The information about the image described above contains information about behavior of the competitor 201.

Note that a method of communication between the first camera 51 and the competition management server 12 is not particularly limited. For example, the same method as the method of communication between the measurement equipment 11 and the competition management server 12 may be used, or another communication method may be used.

Here, the first intersection 31, the first traffic light 41, and the first camera 51 are described. The same holds true for the second intersection 32, the second traffic light 42, and the second camera 52, and the third intersection 33, the third traffic light 43, and the third camera 53.

The competitor 201 passes through the first RFID passing gate 61 at the position of the first RFID passing gate 61. In this case, the measurement equipment 11 and the first RFID passing gate 61 communicate with each other with the RFID communication method in a non-contact manner. Subsequently, the first RFID passing gate 61 transmits information about the communication result to the competition management server 12. The competition management server 12 receives the information about the communication result that is transmitted from the first RFID passing gate 61 to the competition management server 12. For example, the information about the communication result may contain the identification information about the measurement equipment 11 and information about a time at which the measurement equipment 11 passes through the first RFID passing gate 61.

Note that a method of communication between the first RFID passing gate 61 and the competition management server 12 is not particularly limited. For example, the same method as the method of communication between the measurement equipment 11 and the competition management server 12 may be used, or another communication method may be used.

Here, the first RFID passing gate 61 is described. The same holds true for the second RFID passing gate 62 and the third RFID passing gate 63.

Next, the measurement equipment 11 and the competition management server 12 are described in detail.

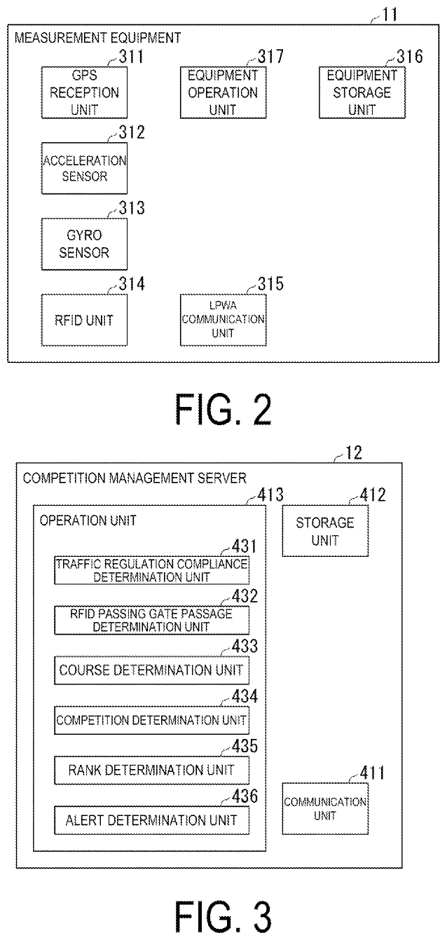

FIG. 2 is a view illustrating a schematic configuration example of the measurement equipment 11 in the exemplary embodiment.

The measurement equipment 11 includes a GPS reception unit 311, an acceleration sensor 312, a gyro sensor 313, an RFID unit 314, an LPWA communication unit 315, an equipment storage unit 316, and an equipment operation unit 317.

The GPS reception unit 311 includes a Global Positioning System (GPS) receiver, receives a signal from a GPS satellite, and acquires time information and positional information, based on the received signal.

Note that the GPS satellite is omitted in illustration. Further, for example, a general technique may be used as a GPS technique, and detailed description therefor is omitted.

In the present exemplary embodiment, it is regarded that the measurement equipment 11 and the competitor 201 on which the measurement equipment 11 is mounted are present at a position specified based on the positional information acquired by the GPS reception unit 311, at a time specified based on the time information acquired by the GPS reception unit 311.

Note that, in the present exemplary embodiment, the GPS is adopted as one example of the GNSS. In other words, in the present exemplary embodiment, it can also be expressed that a GNSS reception unit includes a Global Navigation Satellite System (GNSS) receiver, receives a signal from a GNSS satellite, and acquires time information and positional information, based on the received signal. In this manner, the GNSS is not limited to the GPS, and another configuration may be used.

The acceleration sensor 312 measures acceleration, and has a function of measuring a translational motion in each of three-dimensional axial directions orthogonal to one another, for example.

In the present exemplary embodiment, movement specified based on the measurement result acquired by the acceleration sensor 312 is regarded as movement of the measurement equipment 11 and the competitor 201 on which the measurement equipment 11 is mounted.

The gyro sensor 313 measures an angle speed, and has a function of measuring a posture, for example. In the present exemplary embodiment, a posture specified based on the measurement result acquired by the gyro sensor 313 is regarded as a posture of the measurement equipment 11 and the competitor 201 on which the measurement equipment 11 is mounted.

In the present exemplary embodiment, based on the measurement result acquired by the acceleration sensor 312 and the measurement result acquired by the gyro sensor 313, the movement and the posture of the competitor 201 and the measurement equipment 11 is grasped. With this, the movement of the competitor 201 and the measurement equipment 11 is grasped. The movement of the competitor 201 may also be referred to as behavior of the competitor 201. For example, the behavior of the competitor 201 includes movements that are made when the competitor 201 runs, the competitor 201 stops, the competitor 201 stands, the competitor 201 sits, and the competitor 201 falls down.

In this manner, in the present exemplary embodiment, a function as a motion sensor is achieved by the function of the acceleration sensor 312 and the function the gyro sensor 313.

The RFID unit 314 performs communication with each of the first RFID passing gate 61, the second RFID passing gate 62, and the third RFID passing gate 63 with the RFID communication method in a non-contact manner.

The RFID unit 314 may transmit the identification information about the measurement equipment 11.

The LPWA communication unit 315 includes a communication interface for performing communication, and executes processing of communication through use of the communication interface.

The LPWA communication unit 315 wirelessly communicates with the LPWA base station device 22 with the LPWA communication method. With this, the LPWA communication unit 315 communicates with the competition management server 12.

The LPWA communication unit 315 may contain the identification information about the measurement equipment 11 in the information transmitted to the competition management server 12.

Note that, in the present exemplary embodiment, the identification information about the measurement equipment 11, which is transmitted from the RFID unit 314, and the identification information about the measurement equipment 11, which is contained in the information transmitted from the LPWA communication unit 315 are described without making distinction therebetween. However, different information may be used for those pieces of identification information.

The equipment storage unit 316 stores information. In the present exemplary embodiment, the equipment storage unit 316 may store the identification information about the measurement equipment 11 and the like.

The equipment operation unit 317 performs operations. In the present exemplary embodiment, the equipment operation unit 317 may perform operations relating to each of the GPS reception unit 311, the acceleration sensor 312, the gyro sensor 313, the RFID unit 314, the LPWA communication unit 315, and the equipment storage unit 316.

In the present exemplary embodiment, the equipment operation unit 317 controls each of the GPS reception unit 311, the acceleration sensor 312, the gyro sensor 313, the RFID unit 314, the LPWA communication unit 315, and the equipment storage unit 316.

In the present exemplary embodiment, the equipment operation unit 317 transmit, to the competition management server 12, the time information and the positional information that are acquired by the GPS reception unit 311, the movement information acquired by the acceleration sensor 312, and the posture information acquired by the gyro sensor 313, together with the information that is transmitted from the LPWA communication unit 315 to the competition management server 12.

FIG. 3 is a view illustrating a schematic configuration example of the competition management server 12 in the exemplary embodiment.

The competition management server 12 includes a communication unit 411, a storage unit 412, and an operation unit 413.

The operation unit 413 includes a traffic regulation compliance determination unit 431, an RFID passing gate passage determination unit 432, a course determination unit 433, a competition determination unit 434, a rank determination unit 435, and an alert determination unit 436.

The communication unit 411 includes a communication interface for performing communication, and executes processing of communication through use of the communication interface.

The communication unit 411 communicates with the base station device 22 via the network 21, and thus communicates with the LPWA communication unit 315 of the measurement equipment 11.

The communication unit 411 receives the information transmitted from the measurement equipment 11. In the present exemplary embodiment, the information contains the identification information about the measurement equipment 11, and the time information, the positional information, the movement information, and the posture information that are acquired by the measurement equipment 11.

In the present exemplary embodiment, the movement information and the posture information, which are acquired by the measurement equipment 11, are integrated with the movement information by the equipment operation unit 317 of the measurement equipment 11, and then are transmitted to the competition management server 12. As another example, the movement information and the posture information may be transmitted as different pieces of information.

The communication unit 411 communicates with each of the first RFID passing gate 61, the second RFID passing gate 62, and the third RFID passing gate 63.

The communication unit 411 receives the information about the passage result of the measurement equipment 11, which is transmitted from each of the first RFID passing gate 61, the second RFID passing gate 62, and the third RFID passing gate 63.

In the present exemplary embodiment, the information about the passage result of the measurement equipment 11 indicates the information about the passage result of the competitor 201 on which the measurement equipment 11 is mounted.

The communication unit 411 communicates with each of the first camera 51, the second camera 52, and the third camera 53.

The communication unit 411 receives the information about the image that is captured by and transmitted from each of the first camera 51, the second camera 52, and the third camera 53.

Note that, in the present exemplary embodiment, the communication unit 411 has a function of communicating with each of the measurement equipment 11, the RFID passing gates, and the cameras, but may include independent function units that communicates with the respective elements.

The storage unit 412 stores information. In the present exemplary embodiment, the storage unit 412 may store the information received from the measurement equipment 11.

The operation unit 413 performs operation.

In the present exemplary embodiment, the operation unit 413 controls each of the communication unit 411 and the storage unit 412.

Based on the positional information about the measurement equipment 11, which is received by the communication unit 411, the traffic regulation compliance determination unit 431 determines whether the competitor 201 stops to comply with a traffic regulation under a state in which the first traffic light 41 prohibits proceeding of a pedestrian.

For this determination, the traffic regulation compliance determination unit 431 may use the time information corresponding to the positional information about the measurement equipment 11, which is received by the communication unit 411.

Further, for this determination, the traffic regulation compliance determination unit 431 may use the information about the image captured by the first camera 51, which is received by the communication unit 411. In this case, the traffic regulation compliance determination unit 431 may acquire information relating to the behavior of the competitor 201 by subjecting the captured image to predetermined image processing.

Further, for this determination, the traffic regulation compliance determination unit 431 may use the positional information about the first traffic light 41 and the positional information about the first intersection 31. In this case, for example, those pieces of positional information may be stored in advance in the storage unit 412, may be received by the communication unit 411 from an external device, or may be input to the competition management server 12 in accordance with an operation performed by a manager of the competition.

As those pieces of positional information, map information containing those pieces of positional information may be used.

Here, condition for determining that the traffic regulation is complied with may contain a condition relating to a stoppage time of the competitor 201 at the first traffic light 41. The stoppage time indicates a time during which the competitor 201 stand by until a state in which the first traffic light 41 prohibits proceeding of a pedestrian is switched to a state in which the first traffic light 41 permits proceeding of a pedestrian.

The condition may be a condition for determining that the stoppage time falls within a predetermined range. The range may define one of a lower limit value of the stoppage time and an upper limit value of the stoppage time or both of the values. As a specific example, the range may be “10 seconds or more”, “10 seconds or more and 120 seconds or less”, or “120 seconds or less”.

The traffic regulation compliance determination unit 431 determines the stoppage time of the competitor 201 at the first traffic light 41, based on the positional information and the time information about the measurement equipment 11, which are received by the communication unit 411. For example, this determination may also be presumptive determination.

Subsequently, the traffic regulation compliance determination unit 431 determines whether the determined stoppage time satisfies the stoppage time condition.

Note that the traffic regulation compliance determination unit 431 determines that the competitor 201 stops at the first traffic light 41 when the position of the competitor 201 is not changed at all. In addition, the traffic regulation compliance determination unit 431 may also determine that the competitor 201 stops the first traffic light 41 when the position of the competitor 201 changes but stops at the first traffic light 41. In such a case, for example, it is determined that the position of the competitor 201 changes but the competitor 201 does not cross the pedestrian crosswalk of the first traffic light 41 in some cases.

Further, the condition for determining that the traffic regulation is complied with may contain a condition relating to the behavior of the competitor 201. The condition may be a condition for determining that the competitor 201 stands while the competitor 201 stops at the first traffic light 41. In other words, the condition may be a condition for determining that the competitor 201 does not sit or fall down while the competitor 201 stops at the first traffic light 41.

The traffic regulation compliance determination unit 431 determines whether the condition relating to behavior of the competitor 201 is satisfied, based on the behavior information about the measurement equipment 11, which is received by the communication unit 411.

The traffic regulation compliance determination unit 431 corrects a competition time when the competitor 201 stops to comply with a traffic regulation under a state in which the first traffic light 41 prohibits proceeding of a pedestrian.

In the present exemplary embodiment, the traffic regulation compliance determination unit 431 determines a time during which the competitor 201 stops under a state in which the first traffic light 41 prohibits proceeding of a pedestrian, performs correction of subtracting the determined stoppage time from an actual measurement time, and thus acquired a corrected time.

Here, the traffic regulation compliance determination unit 431 regards, as the actual measurement time, an actual elapse of time since the competitor 201 on which the measurement equipment 11 is mounted leaves the starting point 101.

For example, the actual measurement time may be determined based on one of the GPS time information acquired by the measurement equipment 11 and the times at which the measurement equipment 11 of the competitor 201 passes through the first RFID passing gate 61, the second RFID passing gate 62, and the third RFID passing gate 63, or based on both of the factors. For example, when there is an error in the GPS time information, the traffic regulation compliance determination unit 431 may correct the error, based on the time information about the passage result at each of the RFID passing gates.

In the present exemplary embodiment, while the competitor 201 participates in the competition, the traffic regulation compliance determination unit 431 acquires the actual measurement time and the corrected time in real time.

In another example, after the competitor 201 participates in the competition, the traffic regulation compliance determination unit 431 may acquire the actual measurement time and the corrected time relating to the competition in which the competitor 201 participates.

Note that the actual measurement time and the corrected time may be a time acquired when the competitor 201 is present in the middle of the course 111 and a time acquired when the competitor 201 arrives at the goal point 102.

Here, the operations performed by the traffic regulation compliance determination unit 431 are described in relation to a case in which the competitor 201 stops at the first traffic light 41. The same holds true when the competitor 201 stops at the second traffic light 42 and the competitor 201 stops at the third traffic light 43.

The RFID passing gate passage determination unit 432 determines that the measurement equipment 11 passes through the first RFID passing gate 61, based on the information about the passage result of the measurement equipment 11, which is received by the communication unit 411 from the first RFID passing gate 61.

Here, the operations performed by the RFID passing gate passage determination unit 432 is described in relation to the first RFID passing gate 61. The same holds true for the second RFID passing gate 62 and the third RFID passing gate 63.

The course determination unit 433 determines whether the competitor 201 follows the course 111, based on the positional information about the measurement equipment 11, which is received by the communication unit 411.

In the present exemplary embodiment, information for specifying the course 111 is stored in advance in the storage unit 412.

When the position specified based on the positional information about the measurement equipment 11 is along the course 111, the course determination unit 433 determines that the competitor 201 follows the course 111.

For example, as a condition for determining the position is along the course 111, there may be used a condition for determining that a distance between the position and the course 111 is equal to or less than a predetermined threshold value.

The competition determination unit 434 determines whether the competitor 201 participates in a predetermined competition, based on the behavior information about the measurement equipment 11, which is received by the communication unit 411.

The condition for determining that the competitor 201 participates in a predetermined competition may be set in a freely-selected manner for each of competition events and race types.

As a condition for determining that the competitor 201 participates in, for example, a marathon competition as a competition event, a condition for determining that the competitor 201 stands may be used.

Further, a freely-selected condition may be used for each of race types, such as an amateur race, a collage race, and a local race.

The competition determination unit 434 determines that the competitor 201 participates in a predetermined competition, based on the behavior information about the measurement equipment 11, when a predetermined condition is satisfied.

The rank determination unit 435 determines a rank of the competitor 201, based on a time corrected by the traffic regulation compliance determination unit 431. The rank determination unit 435 determines a time obtained by correcting the actual measurement time required in the competition of the course 111 from the starting point 101 to the goal point 102 for each of a plurality of competitors, and determines a rank of each competitor in the order from the shortest corrected time to the longest corrected time. In other words, a competitor with the shortest corrected time is in the first rank, and a competitor with the longest corrected time is in the lowest rank.

Note that, when a competition is held where ranks of competitors are determined in the order from the longest corrected time to the shortest corrected time, such ranks may be determined.

Here, the rank determination unit 435 may correct an actual measurement time, other than correction of a time, which is performed by the traffic regulation compliance determination unit 431.

For example, such correction may be meteorological correction such as a temperature, humidity, and weather, or correction relating to age.

Further, the rank determination unit 435 may determine whether the competitor 201 commits a foul in the competition. When a predetermined condition is satisfied, the rank determination unit 435 determines that the competitor 201 commits a foul in the competition.

For example, as the condition, one or more selected from the following conditions may be used. The conditions include a condition where the determination result of the traffic regulation compliance determination unit 431 indicates that the competitor 201 does not comply with a traffic regulation at one or more traffic lights, a condition where the determination result of the RFID passing gate passage determination unit 432 indicates that the competitor 201 does not pass through one or more RFID passing gates, a condition where the determination result of the course determination unit 433 indicates that the competitor 201 does not follow the course 111, and a condition where the competition determination unit 434 determines that the competitor 201 does not participate in a predetermined competition.

When it is determined that the competitor 201 commits a foul in the competition, the rank determination unit 435 may execute processing of imposing a predetermined penalty on the competitor 201 who commits a foul.

Any content may be freely selected as the penalty. For example, a penalty may be imposed by disqualifying a competitor for the competition. Alternatively, a penalty may be imposed by performing correction, specifically, adding a predetermined time to an actual measurement time. Alternatively, a penalty may be imposed by adding an additional course to the course 111 of the competition.

Contents of the penalty and a time period to be added as a penalty may be set in a freely-selected manner for each of competition events and race types, for example.

Note that the present exemplary embodiment illustrates a case in which the rank determination unit 435 executes processing of determining presence or absence of a foul committed by the competitor 201 and processing of imposing a penalty when the competitor 201 commits a foul. Alternatively, processing units that executes those types of processing may be independently provided.

The alert determination unit 436 determines whether the behavior of the competitor 201 at the first traffic light 41 is predetermined behavior, based on the behavior information about the measurement equipment 11, which is received by the communication unit 411.

Subsequently, when it is determined that, based on the behavior information, the behavior of the competitor 201 at the first traffic light 41 is the predetermined behavior, the alert determination unit 436 issues an alert.

Here, for example, as the predetermined behavior, one or both of behavior that the competitor 201 sits and behavior that the competitor 201 falls down may be used. In another example, as a condition of the predetermined behavior, there may be used a condition for determining that behavior of the competitor 201 is other than standing.

In the present exemplary embodiment, when the predetermined condition is satisfied, specifically, when the competitor 201 sits or falls down near the first traffic light 41, it is presumed that the competitor 201 may have a traffic accident. Thus, the alert determination unit 436 issues an alert.

As a mode of issuing an alert from the alert determination unit 436, a freely-selected mode may be used. For example, one or more of a mode of outputting a sound such as a voice sound for an alert, a mode of displaying an image for an alert on a display screen, and a mode of transmitting information for an alert from the communication unit 411 to an external device may be used.

For example, when there is a higher-order device that controls the competition management server 12, the external device may be the higher-order device.

Further, for example, the external device may be a monitoring device being a device owned by a monitoring person in the competition. When a plurality of monitoring devices are present at different positions along the course 111, the external device may be one or more monitoring devices including at least one of a monitoring device closest to the first traffic light 41 and a monitoring device closest to the position of the competitor 201.

Here, the operations performed by the alert determination unit 436 are described in relation to the behavior of the competitor 201 at the first traffic light 41. The same holds true for the behavior of the competitor 201 at the second traffic light 42 and the behavior of the competitor 201 at the third traffic light 43.

In the present exemplary embodiment, the alert determination unit 436 issues an alert, based on the behavior of the competitor 201 near the traffic light. The alert determination unit 436 may have a function of issuing an alert, based on the behavior of the competitor 201 at another location.

For example, the alert determination unit 436 determines whether the behavior of the competitor 201 at a location other than the first traffic light 41, the second traffic light 42, and the third traffic light 43 is the predetermined behavior, based on the behavior information about the measurement equipment 11, which is received by the communication unit 411.

Subsequently, when it is determined that, based on the behavior information, the behavior of the competitor 201 at a location other than the first traffic light 41, the second traffic light 42, and the third traffic light 43 is the predetermined behavior, the alert determination unit 436 issues an alert.

In this configuration, when the predetermined condition is satisfied, specifically, when the competitor 201 sits or falls down at a location other than the first traffic light, it is presumed that the competitor 201 may be sick. Thus, the alert determination unit 436 issues an alert.

In this configuration, as a mode of issuing an alert from the alert determination unit 436, a freely-selected mode may be used. For example, one or more of a mode of outputting a sound such as a voice sound for an alert, a mode of displaying an image for an alert on a display screen, and a mode of transmitting information for an alert from the communication unit 411 to an external device may be used.

For example, when there is a higher-order device that controls the competition management server 12, the external device may be the higher-order device.

Further, for example, the external device may be a monitoring device being a device owned by a monitoring person in the competition. When a plurality of monitoring devices are present at different positions along the course 111, the external device may be one or more monitoring devices including a monitoring device closest to the competitor 201.

Here, for example, as a condition for determining that the competitor 201 is present at the first traffic light 41, there may be used a condition that the competitor 201 is present within a range, which is a predetermined range near the first traffic light 41. Alternatively, another condition may be used. Those conditions may be similar for the second traffic light 42 and the third traffic light 43.

Further, for example, as a condition for determining that the competitor 201 is present at a location other than the first traffic light 41, the second traffic light 42, and the third traffic light 43, there may be used a condition where a condition that the competitor 201 is present at the first traffic light 41 is not satisfied, a condition that the competitor 201 is present at the second traffic light 42 is not satisfied, and a condition that the competitor 201 is present at the third traffic light 43 is not satisfied.

Note that, in the present exemplary embodiment, the operations of the alert determination unit 436 are described while making distinction between the case in which the competitor 201 is present at the traffic light and the case in which the competitor 201 is present at a location other than the traffic light. As another example, when it is determined that, based on the behavior information about the measurement equipment 11, which is received by the communication unit 411, the behavior of the competitor 201 is the predetermined behavior, the alert determination unit 436 may issue an alert regardless of a location at which the competitor 201 is present.

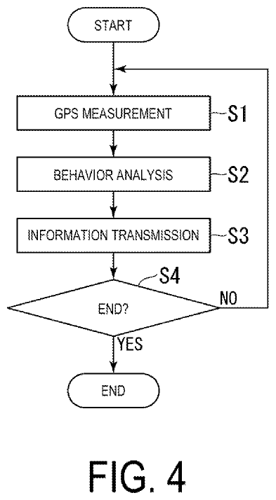

FIG. 4 is a view illustrating one example of a procedure of processing for measurement and transmission of a measurement result, which is executed by the measurement equipment 11, in the exemplary embodiment.

The processing in Step S1 to Step S4 in FIG. 4 is described.

When the power source is turned into an on-state, or an operation with a predetermined button is performed after turning the power source into an on-state, the measurement equipment 11 starts the processing in Step S1. In the present exemplary embodiment, normally, the measurement equipment 11 starts the processing in Step S1 before the competitor 201 starts the competition.

In the processing in Step S1, in the measurement equipment 11, the GPS reception unit 311 performs GPS measurement, and the equipment operation unit 317 acquires a measurement result.

Subsequently, in the processing in Step S2, in the measurement equipment 11, the acceleration sensor 312 performs measurement, and the gyro sensor 313 performs measurement. Then, the equipment operation unit 317 acquires those measurement results, and analyzes the behavior of the competitor 201. In the present exemplary embodiment, the equipment operation unit 317 acquires information obtained as a result of analyzing the behavior of the competitor 201, as behavior information about the competitor 201. In the present exemplary embodiment, the behavior information corresponds to result information obtained as a result of analyzing the behavior of the competitor 201.

Subsequently, in the processing in Step S3, in the measurement equipment 11, the equipment operation unit 317 transmits the time information and the positional information, which are acquired from the GPS measurement results, and the behavior information acquired through the analysis, to the competition management server 12 via the LPWA communication unit 315.

Subsequently, in the processing in Step S4, in the measurement equipment 11, the equipment operation unit 317 determines whether the processing of the present flow is terminated.

As a result of this determination, in the measurement equipment 11, when the equipment operation unit 317 determines that the processing of the present flow is terminated, which indicates YES in Step S4, the processing of the present flow is terminated.

In contrast, as a result of this determination, in the measurement equipment 11, when the equipment operation unit 317 determines that the processing of the present flow is not terminated, which indicates NO in Step S4, the processing proceeds to Step S1.

Here, in the measurement equipment 11, for example, when the power source is turned into an off-state, an operation with a predetermined button is performed, or it is determined that a predetermined condition where the competition is terminated is satisfied, the equipment operation unit 317 terminates the processing of the present flow.

In the present exemplary embodiment, normally, the measurement equipment 11 terminates the processing of the present flow after the competitor 201 finishes the competition.

Note that, in the example of FIG. 4, for convenience of the description, the processing in Step S1, the processing in Step S2, and the processing in Step S3 are illustrated in the stated order. In the measurement equipment 11, part or entirety of those processing may be simultaneously executed in parallel.

Further, in the present exemplary embodiment, the measurement equipment 11 spontaneously executes the processing in Step S1 to Step S4, and the information is transmitted in one-way communication from the measurement equipment 11 to the competition management server 12. As another example, communication may be performed from the competition management server 12 to the measurement equipment 11.

Further, in the present exemplary embodiment, while the competitor 201 participates in the competition, the measurement equipment 11 executes the processing in Step S1 to Step S4 in real time. For example, the processing of information transmission in Step S3 may be executed at another timing. Note that, for example, the real-time processing may be processing of sequentially executing the respective operations in Step S1 to Step S4 at a predetermined cycle.

Further, although omitted in illustration in the example of FIG. 4, in the measurement equipment 11, the processing executed by the RFID unit 314 is executed at each of the first RFID passing gate 61, the second RFID passing gate 62, and the third RFID passing gate 63.

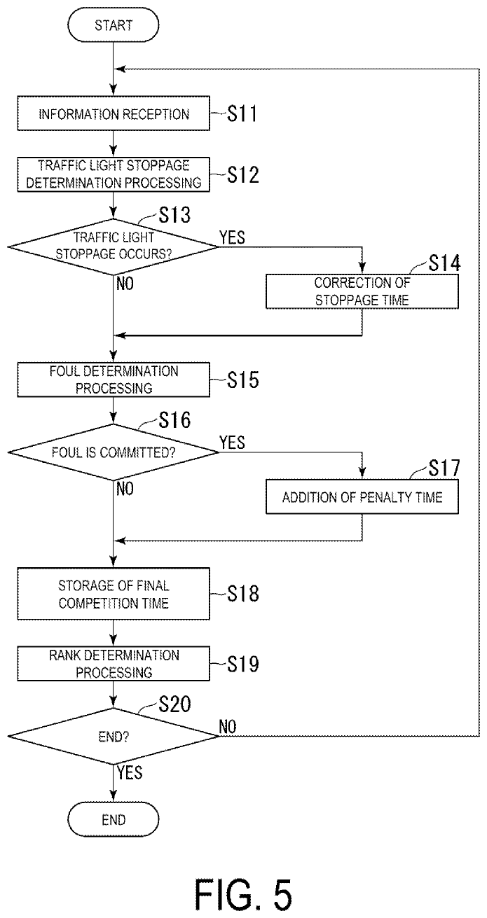

FIG. 5 is a view illustrating one example of a procedure of processing executed by the competition management server 12 in the exemplary embodiment.

The processing in Step S11 to Step S20 in FIG. 5 is described.

When the power source is turned into an on-state, or an operation with a predetermined button is performed after turning the power source into an on-state, the competition management server 12 starts the processing in Step S11.

In the present exemplary embodiment, normally, the competition management server 12 starts the processing in Step S11 before the competitor 201 starts the competition.

In the processing in Step S11, in the competition management server 12, the communication unit 411 receives the information transmitted from the measurement equipment 11, and the operation unit 413 acquires the information. In the present exemplary embodiment, the information contains the time information, the positional information, and the behavior information that are transmitted from the measurement equipment 11.

Subsequently, in the processing in Step S12, in the competition management server 12, the traffic regulation compliance determination unit 431 executes traffic light stop determination processing.

Specifically, in the processing in Step S13, in the competition management server 12, the traffic regulation compliance determination unit 431 determines presence or absence of traffic light stop of the competitor 201 at the first traffic light 41, the second traffic light 42, or the third traffic light 43, based on the information from the measurement equipment 11.

As a result of this determination, in the competition management server 12, when the traffic regulation compliance determination unit 431 determines that traffic light stop of the competitor 201 occurs at the first traffic light 41, the second traffic light 42, or the third traffic light 43, which indicates YES in Step S13, the processing proceeds to Step S14.

In contrast, as a result of this determination, in the competition management server 12, when the traffic regulation compliance determination unit 431 determines that traffic light stop of the competitor 201 does not occur, which indicates NO in Step S13, the processing proceeds to Step S15.

In the processing in Step S14, in the competition management server 12, the traffic regulation compliance determination unit 431 performs correction by subtracting a traffic light stoppage time from the actual measurement time of the competitor 201. Subsequently, in the competition management server 12, the processing proceeds to Step S15.

Here, although omitted in illustration in the example of FIG. 5, in the competition management server 12, one or more processing executed by the RFID passing gate passage determination unit 432, the course determination unit 433, and the competition determination unit 434 may be executed at a freely-selected timing.

In the processing in Step S15, in the competition management server 12, the rank determination unit 435 executes foul determination processing.

Specifically, in the processing in Step S16, in the competition management server 12, the rank determination unit 435 determines whether the competitor 201 commits a foul in the competition.

As a result of this determination, in the competition management server 12, when the rank determination unit 435 determines that the competitor 201 commits a foul in the competition, which indicates YES in Step S16, the processing proceeds to Step S17.

In contrast, as a result of this determination, in the competition management server 12, when the rank determination unit 435 determines that the competitor 201 does not commit a foul in the competition, which indicates NO in Step S16, the processing proceeds to Step S18.

In the processing in Step S17, in the competition management server 12, the rank determination unit 435 adds a penalty time to the time of the competitor 201, in accordance with a committed foul. Subsequently, in the competition management server 12, the processing proceeds to Step S18.

Here, when the actual measurement time is not subjected to correction relating to traffic regulation compliance or the like, the actual measurement time is used as the time to which the penalty time is added. When the actual measurement time is subjected to correction relating to traffic regulation compliance or the like, the time obtained after the correction is used as the time to which the penalty time is added. In other words, in the present exemplary embodiment, when the actual measurement time is corrected twice or more, a time is obtained by reflecting all the corrections in the actual measurement time. The time may be an official time in the competition.

Note that the example of FIG. 5 illustrates the case in which the penalty is imposed by adding a time to the actual measurement time. As another example, the penalty may be imposed by adding an additional course to the course 111 of the competition or disqualifying a competitor for the competition.

In the processing in Step S18, in the competition management server 12, the rank determination unit 435 executes processing of storing, in the storage unit 412, information for specifying a final competition time being a time of the competitor 201, which is finally confirmed in the competition.

When the actual measurement time is not subjected to correction at all, the actual measurement time is used as the final competition time. When the actual measurement time is subjected to freely-selected correction for once or more, which relates to traffic regulation compliance or the like, the time obtained performing all the corrections is used as the final competition time.

Subsequently, in the processing in Step S19, in the competition management server 12, the rank determination unit 435 executes processing of determining a rank of the competitor 201 in the competition, based on the final competition time of the competitor 201.

For example, when a plurality of competitors including the competitor 201 are present, the rank determination unit 435 determines a rank of each of the competitors, based on the final competition time of each of the competitors.

Here, in the competition management server 12, the rank determination unit 435 may transmit information about the rank determination result to an external device via the communication unit 411.

The external device may be a freely-selected device. For example, the external device may be a device of a manager of the competition. Alternatively, when the competition has an audience, the external device may be a device of the audience.

Note that the rank determination unit 435 may transmit freely-selected information about the competitor 201, which relates to the competition, to the external device, in addition to the information about the rank determination result.

Subsequently, in the processing in Step S20, in the competition management server 12, the operation unit 413 determines whether the processing of the present flow is terminated.

As a result of this determination, in the competition management server 12, when the operation unit 413 determines that the processing of the present flow is terminated, which indicates YES in Step S20, the processing of the present flow is terminated. In contrast, as a result of this determination, in the competition management server 12, when the operation unit 413 determines that the processing of the present flow is not terminated, which indicates NO in Step S20, the processing proceeds to Step S11.

Here, in the competition management server 12, for example, when the power source is turned into an off-state, an operation with a predetermined button is performed, or it is determined that a predetermined condition where the competition is terminated is satisfied, the operation unit 413 terminates the processing of the present flow.

In the present exemplary embodiment, normally, the competition management server 12 terminates the processing of the present flow after the competitor 201 finishes the competition.

Note that, in the example of FIG. 5, for convenience of the description, the processing in Step S11, the processing in Step S12 to Step S14, the processing in Step S15 to Step S17, the processing in Step S18, and the processing in Step S19 are illustrated in the stated order. In the competition management server 12, part or entirety of those processing may be simultaneously executed in parallel.

Further, in the present exemplary embodiment, while the competitor 201 participates in the competition, the competition management server 12 executes the processing in Step S11 to Step S20 in real time. As another example, the competition management server 12 may executes the processing in Step S11 to Step S20 after the competitor 201 finishes the competition. Note that, for example, the real-time processing may be processing of sequentially executing the respective operations in Step S11 to Step S20 at a predetermined cycle.

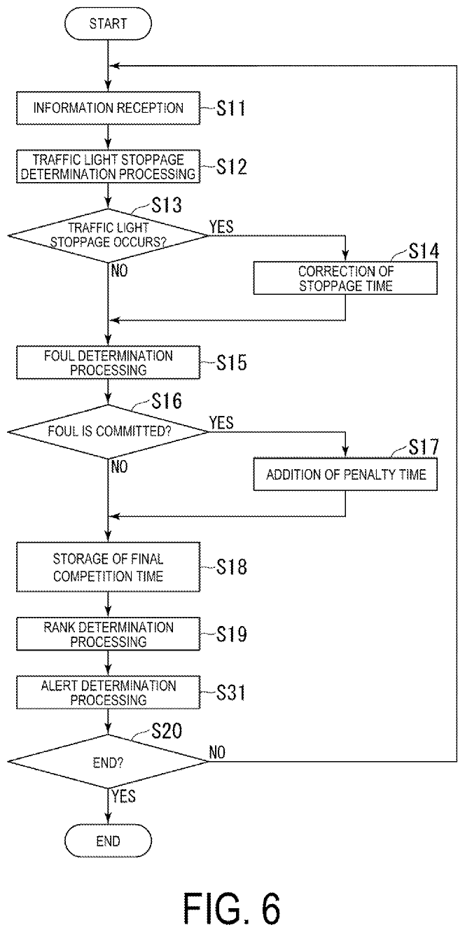

With reference to FIG. 6, a modification example of the processing flow illustrated in FIG. 5 is given.

FIG. 6 is a view illustrating another example of the procedure of the processing executed by the competition management server 12 in the exemplary embodiment.

Schematically, as compared to the processing flow illustrated in FIG. 5, the processing in Step S31 is added between the processing in Step S19 and the processing in Step S20 in the processing flow illustrated in FIG. 6, and the processing from Step S1 to Step S20 is similar to that illustrated in FIG. 5. Note that Step S1 to Step S20 in FIG. 6 are denoted with the same reference symbols as those in FIG. 5.

With regard to the processing flow illustrated in FIG. 6, the processing in Step S31 is described.

In the example of FIG. 6, in the competition management server 12, the processing proceeds to Step S31 after the processing in Step S19.

In the processing of Step S31, in the competition management server 12, the alert determination unit 436 executes alert determination processing.

Specifically, the alert determination unit 436 determines whether the behavior of the competitor 201 at the first traffic light 41, the second traffic light 42, or the third traffic light 43 is the predetermined behavior. Subsequently, when it is determined that the behavior of the competitor 201 at the first traffic light 41, the second traffic light 42, or the third traffic light 43 is the predetermined behavior, the alert determination unit 436 issues an alert. Subsequently, in the competition management server 12, the processing proceeds to Step S20.

Note that, in the processing in Step S31, the alert determination unit 436 may execute the alert determination processing when the competitor 201 is present at a location other than the traffic light, as well as the alert determination processing when the competitor 201 is present at the traffic light.

Further, as the timing at which the alert determination unit 436 executes the alert determination processing, another freely-selected timing can be used.

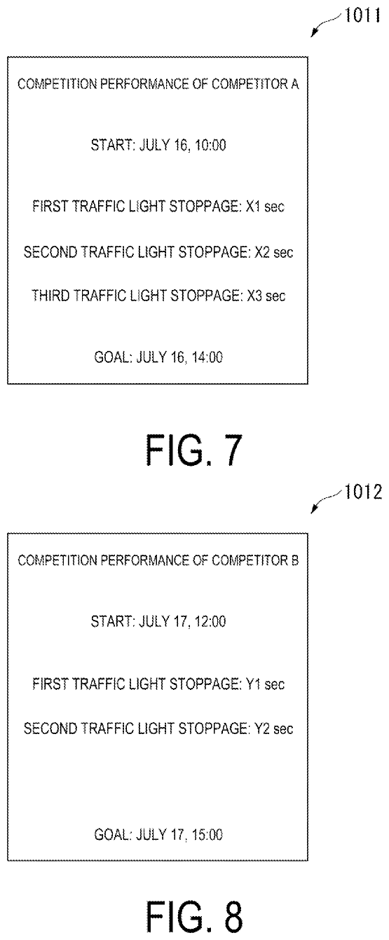

With reference to FIG. 7 to FIG. 10, a specific example of competition performances and competition results of competitors is illustrated.

In the present example, it is assumed that the competitor A and the competitor B are individual competitors. Each of the competitor A and the competitor B is one example of the competitor 201.

There is given a case in which the competitor A and the competitor B participate in the same competition of the course 111 on different dates or at different times. Note that different dates or different times may indicate that, for example, competition starting dates are different, or times are different on the same competition starting date. Further, there may be a case in which two or more competitors start the competition on the same date at the same time.

FIG. 7 is a view illustrating one example of A-th competition performance information 1011 about the competitor A in the exemplary embodiment. The A-th competition performance information 1011 is information indicating a competition performance of the competitor A, and is stored and managed in the storage unit 412 by the competition management server 12, for example.

In the example of FIG. 7, the A-th competition performance information 1011 stores information indicating that the competitor A leaves the starting point 101 on July 16, at 10:00, information indicating that a first traffic light stoppage time is X1 [sec], information indicating that a second traffic light stoppage time is X2 [sec], information indicating that a third traffic light stoppage time is X3 [sec], and information indicating that an arrival time at the goal point 102 is July 16, at 14:00.

Here, in the present example, the first traffic light stop, the second traffic light stop, and the third traffic light stop indicate traffic light stop at the first traffic light 41, traffic light stop at the second traffic light 42, and traffic light stop at the third traffic light 43, respectively.

Further, X1, X2, and X3 indicate values of the stoppage times at the respective traffic lights.

FIG. 8 is a view illustrating one example of B-th competition performance information 1012 about the competitor B in the exemplary embodiment. The B-th competition performance information 1012 is information indicating a competition performance of the competitor B, and is stored and managed in the storage unit 412 by the competition management server 12, for example.

In the example of FIG. 8, the B-th competition performance information 1012 stores information indicating that the competitor B leaves the starting point 101 on July 17, at 12:00, information indicating that a first traffic light stoppage time is Y1 [sec], information indicating that a second traffic light stoppage time is Y2 [sec], and information indicating that an arrival time at the goal point 102 is July 17, at 15:00.

Here, in the present example, the first traffic light stop and the second traffic light stop indicate traffic light stop at the first traffic light 41 and traffic light stop at the second traffic light 42, respectively. Note that the combination of the traffic light for the first traffic light stop and the traffic light for the second traffic light stop may be a combination of other two traffic lights.

Further, Y1 and Y2 indicate stoppage time values of the respective traffic lights.

Here, in the examples of FIG. 7 and FIG. 8, there is given a mode in which the competition performance information does not store stoppage time information relating to a traffic light at which a stoppage time is not generated. As another example, there may be adopted a mode in which the competition performance information stores information indicating that a stoppage time is 0 [sec] at a traffic light at which a stoppage time is not generated.

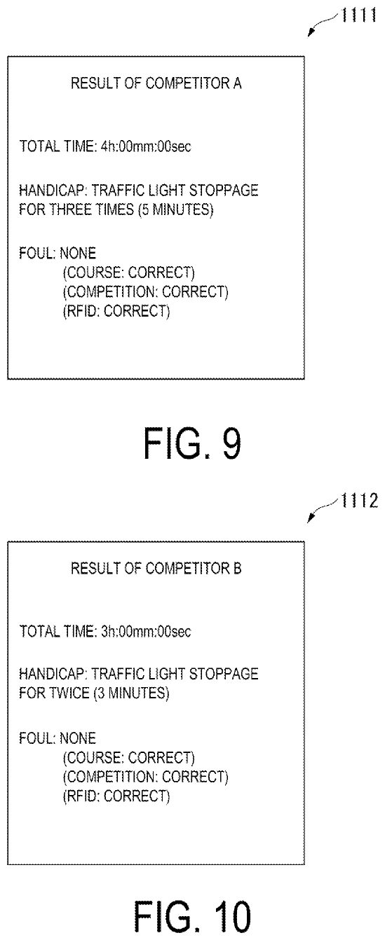

FIG. 9 is a view illustrating one example of A-th competition result information 1111 about the competitor A in the exemplary embodiment. The A-th competition result information 1111 is information indicating a competition result of the competitor A, and is stored and managed in the storage unit 412 by the competition management server 12, for example.

In the example of FIG. 9, the A-th competition result information 1111 stores information indicating that a competition total time is 4 h:00 mm:00 sec, information indicating that a handicap for correction is 5 minutes in total due to traffic light stop for three times, and information indicating that no foul is committed. The information indicating that no foul is committed contains information indicating that the course is correct, information indicating that the competition event is correct, and information indicating that passage through the RFID passing gates is performed correctly.

Here, the total time indicates the actual measurement time.

Further, in the example of FIG. 9, the stoppage time at the traffic light is given as a handicap time. The A-th competition result information 1111 may contain information about another handicap time due to weather conditions.

Further, when the competitor A commits a foul in the competition, the A-th competition result information 1111 may contain information about a time for correcting the actual measurement time, in accordance with the foul.

FIG. 10 is a view illustrating one example of B-th competition result information 1112 about the competitor B in the exemplary embodiment.

The B-th competition result information 1112 is information indicating a competition result of the competitor B, and is stored and managed in the storage unit 412 by the competition management server 12, for example.

In the example of FIG. 10, the B-th competition result information 1112 stores information indicating that a competition total time is 3 h:00 mm:00 sec, information indicating that a handicap for correction is 3 minutes in total due to traffic light stop for twice, and information indicating that no foul is committed. The information indicating that no foul is committed contains information indicating that the course is correct, information indicating that the competition event is correct, and information indicating that passage through the RFID passing gates is performed correctly.

Here, the total time indicates the actual measurement time.

Further, in the example of FIG. 10, the stoppage time at the traffic light is given as a handicap time. The B-th competition result information 1112 may contain information about another handicap time due to weather conditions.

Further, when the competitor B commits a foul in the competition, the B-th competition result information 1112 may contain information about a time for correcting the actual measurement time, in accordance with the foul.

As described above, in the information processing system 1 according to the present exemplary embodiment, in the competition management server 12, the communication unit 411 receives the information transmitted from the measurement equipment 11 mounted on the competitor 201 who participates in the competition. Subsequently, in the competition management server 12, the traffic regulation compliance determination unit 431 determines that the competitor stops to comply with a traffic regulation under a state in which the traffic light prohibits proceeding, based on the GNSS positional information about the measurement equipment 11, which is received by the communication unit 411. In this case, the competition time is corrected.

Specifically, in the information processing system 1 according to the present exemplary embodiment, even when the competitor 201 is required to stop at a position of a traffic light due to a stop instruction from the traffic light installed at an intersection or the like, the time of the competitor 201 can be acquired in consideration of the stoppage time due to the traffic light.

Therefore, in the information processing system 1 according to the present exemplary embodiment, even when the respective competitors 201 participate in the competition on different dates or at different times, the competitors can be timed with less influence of indefinite traffic situations on the respective dates or at the respective times. With this, in the information processing system 1 according to the present exemplary embodiment, unfairness in a competition condition, which is caused by differences in traffic situations, can be suppressed, and thus the competition can be held in a fairer and stricter manner.

Further, in the information processing system 1 according to the present exemplary embodiment, the corrected time of each of the competitors 201 can be acquired in real time. For example, the corrected time is displayed in real time on a device at a check-point in the course 111, which appeals to emotions of participants such as an audience. With this, the competition can be more exciting.

Note that, in the information processing system 1 according to the present exemplary embodiment, the corrected time of each of the competitors 201 may be acquired after each of the competitors 201 finishes the competition.

As one configuration example, the information processing system 1 according to the present exemplary embodiment relates to traffic regulation compliance determination executed by the competition management server 12, and the condition for determining that the traffic regulation is complied with contains a condition relating to a stoppage time of the competitor 201 at a traffic light.

Therefore, in the information processing system 1 according to the present exemplary embodiment, when the stoppage time of the competitor 201 at the traffic light is reasonable, it can be determined that a traffic regulation is complied with. With this, in the information processing system 1 according to the present exemplary embodiment, the competitor 201 can be prevented from committing a foul by stopping at the traffic light for an unreasonable stoppage time.

As one configuration example, in the information processing system 1 according to the present exemplary embodiment, with regard to traffic regulation compliance determination executed in the competition management server 12, the condition for determining that the traffic regulation is complied with contains the condition relating to behavior of the competitor 201. Subsequently, in the competition management server 12, the traffic regulation compliance determination unit 431 determines that the condition relating to behavior of the competitor 201 is satisfied, based on the behavior information about the measurement equipment 11, which is received by the communication unit 411.

Therefore, in the information processing system 1 according to the present exemplary embodiment, when the condition relating to behavior of the competitor 201 is satisfied, it can be determined that the traffic regulation is complied with. With this, in the information processing system 1 according to the present exemplary embodiment, the competitor can be prevented from committing a foul by behaving inappropriately at the position of the traffic light against the rule of the competition.

As one configuration example, in the information processing system 1 according to the present exemplary embodiment, with regard to traffic regulation compliance determination executed in the competition management server 12, the condition relating to behavior of the competitor 201 is a condition for determining that the competitor 201 stands.

Therefore, in the information processing system 1 according to the present exemplary embodiment, when the condition relating to behavior of the competitor, for example, the condition for determining that the competitor stops while standing at the position of the traffic light is satisfied, it can be determined that a traffic regulation is complied with. With this, in the information processing system 1 according to the present exemplary embodiment, the competitor can be prevented from committing a foul by behaving inappropriately at the position of the traffic light against the rule of the competition.

As one configuration example, in the information processing system 1 according to the present exemplary embodiment, in the competition management server 12, the alert determination unit 436 issues an alert when the positional information received by the communication unit 411 indicates that the behavior of the competitor 201 near the traffic light is the predetermined behavior, the behavior information about the measurement equipment 11, which is received by the communication unit 411. For example, the predetermined behavior may be a behavior that the competitor 201 sits or falls down.

Therefore, in the information processing system 1 according to the present exemplary embodiment, when the competitor 201 performs the predetermined behavior, that is, the competitor 201 sits or falls down at the position near the traffic light, an alert is issue to a manager of the competition or the like. With this, the manager can be notified that a traffic accident may occur.

Note that, in such a case, the competitor 201 may feel sick instead of possibly having a traffic accident.

As one configuration example, in the information processing system 1 according to the present exemplary embodiment, in the competition management server 12, the communication unit 411 receives, from the RFID passing gate, the information about the passage result of the measurement equipment 11, and the RFID passing gate passage determination unit 432 determines that the measurement equipment 11 passes through the RFID passing gate, based on the information about the passage result, which is received by the communication unit 411.

Therefore, in the information processing system 1 according to the present exemplary embodiment, passage of the competitor 201 through the RFID passing gate can be confirmed. With this, in the information processing system 1 according to the present exemplary embodiment, the competitor 201 can be prevented from committing a foul by not passing through the RFID passing gate.

Note that the RFID passing gate may not necessarily used in the competition.

As one configuration example, in the information processing system 1 according to the present exemplary embodiment, the competition has the predetermined course 111. In the competition management server 12, the course determination unit 433 determines whether the competitor 201 follows the course 111, based on the positional information received from the communication unit 411.

Therefore, in the information processing system 1 according to the present exemplary embodiment, it can be confirmed that the competitor 201 follows the course 111. With this, in the information processing system 1 according to the present exemplary embodiment, the competitor 201 can be prevented from committing a foul by not following the course 111.

Note that the present exemplary embodiment illustrates the case in which the information processing system 1 is applied to the competition having the predetermined course 111. As another example, the information processing system 1 may be applied to a competition without the predetermined course 111.

As one configuration example, in the information processing system 1 according to the present exemplary embodiment, in the competition management server 12, the competition determination unit 434 determines that the competitor 201 participates in the predetermined competition, based on the behavior information about the measurement equipment 11, which is received by the communication unit 411.

Therefore, in the information processing system 1 according to the present exemplary embodiment, for example, it is confirmed that the competitor 201 continues a running motion during the virtual marathon race. In this manner, it can be confirmed that the competitor 201 performs an appropriate motion for the competition. With this, in the information processing system 1 according to the present exemplary embodiment, the competitor 201 can be prevented from committing a foul by not participating in the predetermined competition.

As one configuration example, in the information processing system 1 according to the present exemplary embodiment, in the competition management server 12, the rank determination unit 435 determines a rank of the competitor 201, based on the time corrected by the traffic regulation compliance determination unit 431.

Therefore, in the information processing system 1 according to the present exemplary embodiment, the rank of the competitor 201 can be determined based on the time of the competitor 201 in consideration of the stoppage time due to the traffic light. Here, in the competition management server 12, the rank determination unit 435 may correct a time, based on differences in various environmental conditions such as weather, in addition to the stoppage time due to the traffic light.

Note that the present exemplary embodiment illustrates the case in which the information processing system 1 is capable of auxiliary uses an image captured by the camera installed in the vicinity of the traffic light and using the image processing result obtained from the captured image for determination. Such a camera is not necessarily used.

Here, the present exemplary embodiment illustrates the case in which the information processing system 1 is applied to the virtual marathon race as a virtual sport event.

Alternatively, the information processing system 1 may be applied to another competition event.

In addition to a marathon in which a competitor runs through a town, examples of the competitions include trail running, swimming in a pool, a race among people riding bicycles or motorcycles, and a triathlon.

Note that, in a competition where a competitor rides a bicycle or a motorcycle, the competitor sits on a seat of the bicycle or the like. Thus, for example, the condition for determining a competitor stands is not a necessary requirement.

In this manner, in the information processing system 1 according to the present exemplary embodiment, a plurality of competitors can participate in the same competition race on different dates or at different times, respectively. Thus, a virtual sport even without depending on a traffic light situation during the competition can be successfully held.

As a specific example, even when a large number of competitors are originally intended to participate in a competition at the same time, small-scale competitions are held on different dates or at different times, and a loss time due to traffic light stop is subtracted from an actual measurement time. With this, a time of each of the participating competitors can be acquired in a fair manner, and a rank can be determined in a fair manner.

Further, the present exemplary embodiment illustrates one example in which the respective functions of the information processing system 1 are provided separately in the measurement equipment 11 and the competition management server 12 being one example of the information processing device. The respective functions of the information processing system may be provided separately in two or more devices in a freely-selected mode.

For example, it is assumed that, as in the present exemplary embodiment, the respective functions of the information processing system are provided separately in the measurement equipment and the information processing. In this case, in the configuration of transmitting the information acquired by the measurement equipment to the information processing device, the measurement equipment may subject the acquired information to processing up to a freely-selected step, and then may transmit the resultant to the information processing device. In other words, when the information acquired by the measurement equipment is subjected to processing in the measurement equipment and the information processing device, the measurement equipment may subject the information to processing up to a freely-selected step, and the information processing device executes processing after the freely-selected step.

As a specific example, there may be adopted a configuration in which the measurement equipment executes information processing until a stoppage time at a traffic light is acquired and then transmits the information about the acquired stoppage time to the information processing device.

Further, the present exemplary embodiment illustrates the case in which the respective functions of the information processing system 1 are provided separately in the measurement equipment 11 and the competition management server 12 being one example of the information processing device. As another example, the information processing system 1 may be configured as one integrated system. Such an integrated system may be configured as the measurement equipment. For example, the measurement equipment may have functions for executing all the processing executed by the measurement equipment 11 and the competition management server 12 in the present exemplary embodiment.

As one configuration example, in the information processing system, the GNSS reception unit is mounted on a competitor who participates in a competition, and acquires GNSS positional information. The traffic regulation compliance determination unit determines that the competitor stops to comply with a traffic regulation under a state in which a traffic light prohibits from proceeding, based on the positional information acquired by the GNSS reception unit. In this case, a competition time is corrected.

A program for achieving the functions of any one of the constituent elements of any one of the devices described above may be recorded in a computer-readable recording medium, and the program may be executed by causing a computer system to read the program. The “computer system” referred herein includes an operating system or hardware of peripheral equipment or the like. The “computer-readable recoding medium” is a storage device including a portable medium such as a flexible disk, a magneto-optical disk, a Read Only Memory (ROM), and a Compact Disc (CD) ROM and a hard disk incorporated in the computer system. It is assumed that the “computer-readable recoding medium” includes a server to which the program is transmitted via a network such as the Internet or a communication line such as a telephone line, or a medium that stores the program for a predetermined time period, such as a volatile memory inside the computer system being a client. The volatile memory may be a RAM. The recording medium may be a non-temporal recording medium.

The program described above may be transmitted from the computer system, which stores the program in the storage device or the like, to another computer system via a transmission medium or a transmission wave in a transmission medium. The “transmission medium” that transmits the program refers to a medium having a function of transmitting information, like a network such as the Internet or a communication line such as a telephone line.

The program described above may be a program for partially achieving the above-mentioned functions. The program described above may be a program capable of achieving the above-mentioned functions in combination with a program that is recorded in advance in the computer system, that is, a so-called differential file. The differential file may be referred to as a differential program.

The functions of any one of the constituent elements of any one of the devices described above may be achieved by a processor. The respective processing in the exemplary embodiment may be achieved by the processor operated based on information such as a program and the computer-readable recording medium that stores the information such as a program. In the processor, the functions of the respective elements may be achieved by individual hardware pieces, or the functions of the respective elements may be achieved by integrated hardware. The processor includes hardware, and the hardware may include at least one of a circuit for processing a digital signal and a circuit for processing an analog signal. The processor may be configured by using one or both of one or a plurality of circuit devices and one or a plurality of circuit elements, which are mounted on a circuit board. An Integrated Circuit (IC) may be used as the circuit device, a resistor or a capacitor may be used as the circuit element.

The processor may be a CPU. However, the processor is not limited to a CPU, and various processors such as a Graphics Processing Unit (GPU) a Digital Signal Processor (DSP) may be used. The processor may be a hardware circuit of an Application Specific Integrated Circuit (ASIC). The processor may be configured as a plurality of CPUs or a hardware circuit of a plurality of ASICs. The processor may be configured as a combination of a plurality of CPUs and a hardware circuit of a plurality of ASICs. The processor may include one or more of an amplifier circuit for processing an analog signal and a filter circuit.

With reference to the drawings, the exemplary embodiment is described above in detail. The specific configuration is not limited to the exemplary embodiment, and encompasses designs and the like within the gist of the present disclosure.

What is claimed is:

1. An information processing device, comprising:
a communication unit configured to communicate with a measurement equipment mounted on a competitor who participates in a competition; and
a traffic regulation compliance determination unit configured to correct a time of the competition when determining, based on positional information of the measurement equipment, that the competitor is complying with a traffic regulation stopping the competitor from proceeding while the competitor is prohibited from proceeding.

2. The information processing device according to claim 1, wherein
a condition for determining that the traffic regulation is complied with includes a condition relating to a stoppage time at a traffic light.

3. The information processing device according to claim 1, wherein
the condition for determining that the traffic regulation is complied with includes a condition relating to behavior of the competitor, and
the traffic regulation compliance determination unit determines, based on behavior information of the measurement equipment, that the condition relating to behavior of the competitor is satisfied.

4. The information processing device according to claim 3, wherein
the condition relating to behavior of the competitor is a condition that the competitor is standing.

5. The information processing device according to claim 2, comprising
an alert determination unit configured to issue an alert when determining, based on the behavior information of the measurement equipment, that behavior of the competitor whose positional information, received by the communication unit, indicates a location near the traffic light is predetermined behavior.

6. The information processing device according to claim 1, comprising
an RFID passing gate passage determination unit configured to determine, based on information about a passage result received by the communication unit, that the measurement equipment passes through an RFID passing gate,
the communication unit communicating with the RFID passing gate to receive the information about the passage result of the measurement equipment from the RFID passing gate.

7. The information processing device according to claim 1, comprising
a course determination unit configured to determine, based on the positional information received by the communication unit, that the competitor is following a course,
the course being set for the competition.

8. The information processing device according to claim 1, comprising
a competition determination unit configured to determine, based on the behavior information, received by the communication unit, of the measurement equipment, that the competitor is participating in a predetermined competition.

9. The information processing device according to claim 1, comprising
a rank determination unit configured to determine a rank of the competitor, based on the time corrected by the traffic regulation compliance determination unit.

10. An information processing system, comprising:
a GNSS reception unit mounted on a competitor who participates in a competition, and configured to acquire positional information of the competitor; and
a traffic regulation compliance determination unit configured to correct a time of the competition when determining, based on the positional information, that the competitor is complying with a traffic regulation stopping the competitor from proceeding while the competitor is prohibited from proceeding.
